(19) United States
(12) Patent Application Publication
(10) Pub. No.: US 2007/0233558 A1
(43) Pub. Date: Oct. 4, 2007

(54) Mobile trading card redemption

(76) Inventors: Kenneth A. Jones, Newburyport, MA (US); Peter C. Fuller, Mountain View, CA (US); Brian F. Kathman, Alexandria, VA (US)

Correspondence Address: ROBERT PLOTKIN, PC, 45 BUTTERNUT CIRCLE, CONCORD, MA, 01742-1937, US

(21) Appl. No.: 11/396,827

(22) Filed: Apr. 3, 2006

(51) Int. Cl. G06Q 30/00

(52) U.S. Cl. 705/14

(57) ABSTRACT

A computer-implemented system distributes digital content (such as electronic trading cards) to users and receives such content back from the users. Consideration, such as rewards, may be provided to users in exchange for the digital content they return to the system. For example, a redemption program may provide a reward to users who redeem a specified group of electronic trading cards. Users may trade digital content with each other, and a user who returns a particular unit of digital content need not be the user to whom the digital content unit was originally distributed. Cards may be individually identifiable, enabling both the original recipient of a digital content unit and the redeeming user to be identified. Each user may use the system to keep track of the digital content units that the user has returned to the system so far.

### CROSS REFERENCE TO RELATED APPLICATIONS

This application is related to a commonly-owned and concurrently-filed application entitled “Mobile Trading Card Generation and Distribution,” which is hereby incorporated by reference herein.

### BACKGROUND

1. Field of the Invention

The present invention relates to generation and distribution of digital content and, more particularly, to generation and distribution of electronic trading cards for use with mobile devices.

2. Related Art

Trading cards, including baseball cards and cards related to movies and other events, remain popular among people of all ages, decades after they were first introduced. Most trading cards are still generated and distributed in the same manner as in the early twentieth century. Consider baseball cards, for example. Before the beginning of a new baseball season, a baseball card manufacturer gathers information about sports teams and individual players from the previous season. Such information includes both statistics and photographs of the players. The manufacturer then designs a card for each player. Typically, the front of the card includes a photograph of the player and the name and/or logo of the player's team, while the back of the card includes statistics related to the player, such as the player's batting. average.

The manufacturer compiles a “set” of such cards, which may also include certain special cards, such as cards representing entire teams or most-valuable players (MVPs). The set typically includes a finite number of cards (e.g., 800), each of which is numbered. The manufacturer then uses conventional printing presses to print large runs of the sets of cards. Some cards may be printed in different quantities than others. For example, the manufacturer may print only a small number of copies of a card representing an MVP, while the manufacturer may print a large number of copies of a card representing an average player. The result is a finite number of copies of each card in the set for the upcoming season.

The manufacturer sells and distributes the cards primarily in one of two ways. First, the manufacturer may generate packs of cards, each of which contains a small number (e.g., three) of cards randomly selected from the print run. Each pack is sealed in a wrapper and sold and distributed to retail outlets such as supermarkets and convenience stores. As a result, when a baseball fan browses through packs of cards available for sale, it is not possible for the fan to identify the cards in a pack without purchasing the pack and opening the wrapper. Fans typically seek to obtain a complete set of cards. This method of selling randomly-generated packs, the contents of which are not visible until after sale, therefore generates additional sales of card packs by fans seeking to obtain complete sets of cards.

Second, the manufacturer may sell and distribute complete sets of cards to collectors and card retailers. Fans typically are willing to pay a premium for a complete set of cards sold in this manner, because of the convenience it provides by avoiding the need for the fan to complete a set by purchasing large numbers of random card packs.

Fans often trade cards with each other in an attempt to obtain complete card sets. The difference in scarcity among different cards often plays out in card trading. For example, a fan with a particularly rare card may be able to obtain several more common cards from another fan in exchange for the rare card. Fans often use trading cards in other ways, such as by using them as the basis for games. Furthermore, although the discussion above refers to baseball cards, trading cards frequently relate to other topics, including not only other sports, but also movies, music, and video games.

### SUMMARY

A computer-implemented system distributes digital content (such as electronic trading cards) to users and receives such content back from the users. Consideration, such as rewards, may be provided to users in exchange for the digital content they return to the system. For example, a redemption program may provide a reward to users who redeem a specified group of electronic trading cards. Users may trade digital content with each other, and a user who returns a particular unit of digital content need not be the user to whom the digital content unit was originally distributed. Cards may be individually identifiable, enabling both the original recipient of a digital content unit and the redeeming user to be identified. Each user may use the system to keep track of the digital content units that the user has returned to the system so far.

For example, one aspect of the present invention is directed to a computer-implemented method including: (A) identifying at least one electronic trading card instance transmitted by a user over a network to a redemption processor; (B) determining whether the at least one electronic trading card instance satisfies at least one predetermined redemption criterion; and (C) if the at least one electronic trading card instance satisfies the at least one predetermined redemption criterion, providing the user with predetermined consideration in exchange for the at least one electronic trading card instance.

Another aspect of the present invention is directed to a computer-implemented method including: (A) transmitting at least one electronic trading card instance over a network to a redemption processor, the at least one electronic trading card instance satisfying at least one predetermined redemption criterion; and (B) receiving predetermined consideration in exchange for the at least one electronic trading card instance.

Yet another aspect of the present invention is directed to a computer-implemented method including: (A) receiving an indication of a digital content unit transmitted by a transmitting user over a network to a tracking server; (B) identifying the transmitting user; and (C) storing an indication that the transmitting user has transmitted the digital content unit to the tracking server.

Other features and advantages of various aspects and embodiments of the present invention will become apparent from the following description and from the claims.

### BRIEF DESCRIPTION OF THE DRAWINGS

FIGS. 1A-1D are dataflow diagrams of systems for generating, distributing, and redeeming electronic trading cards according to embodiments of the present invention;

FIG. 2A is a diagram illustrating the structure of a redemption program definition record according to one embodiment of the present invention;

FIG. 2B is a diagram illustrating a representation of a set of electronic trading cards required by a redemption program according to one embodiment of the present invention;

FIG. 2C is a diagram illustrating a record of the state of a redemption program according to one embodiment of the present invention;

FIG. 2D is a diagram illustrating a record of a user's progress towards satisfying the redemption criteria of a redemption program according to one embodiment of the present invention; and

FIG. 3 is a flowchart of a method performed by the system of FIG. 1A according to one embodiment of the present invention.

### DETAILED DESCRIPTION

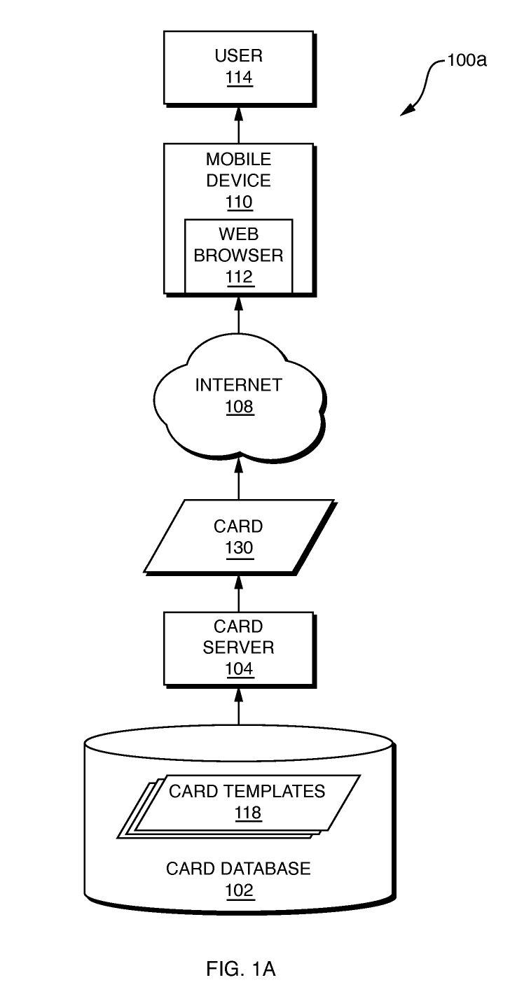

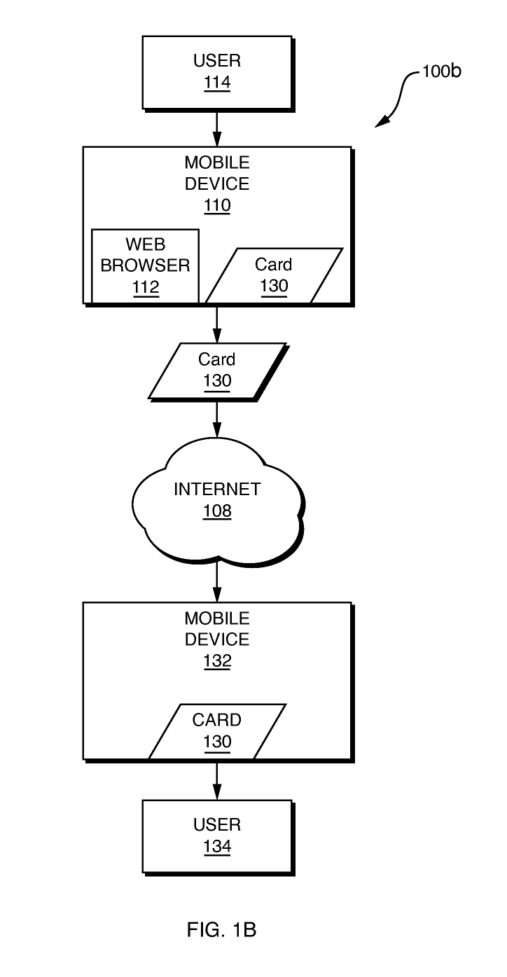

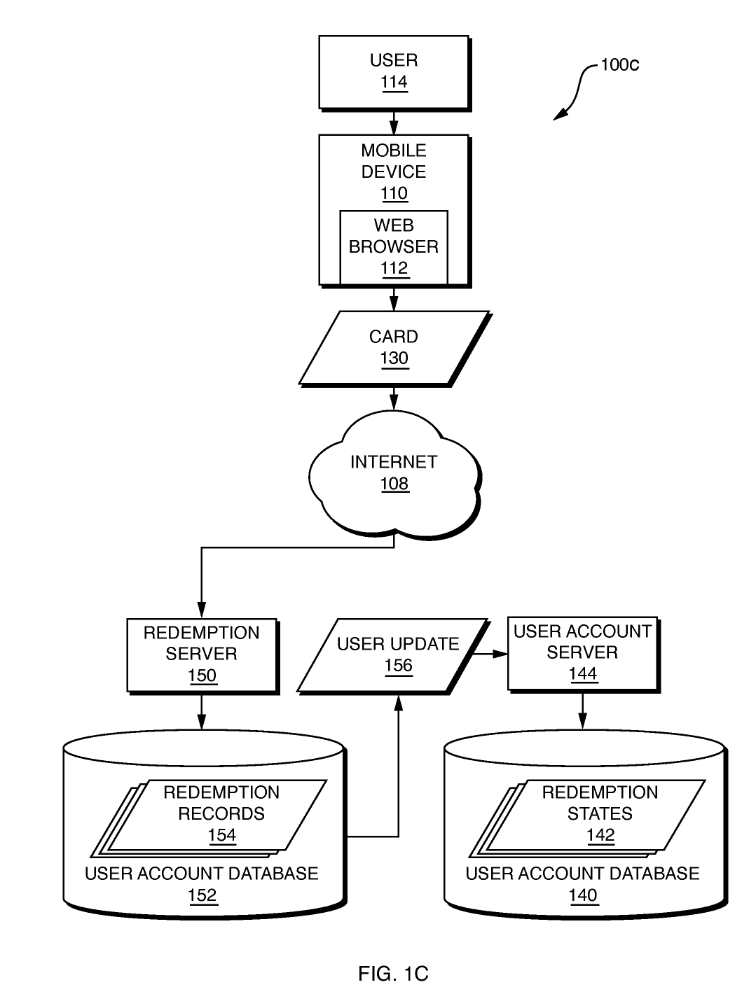

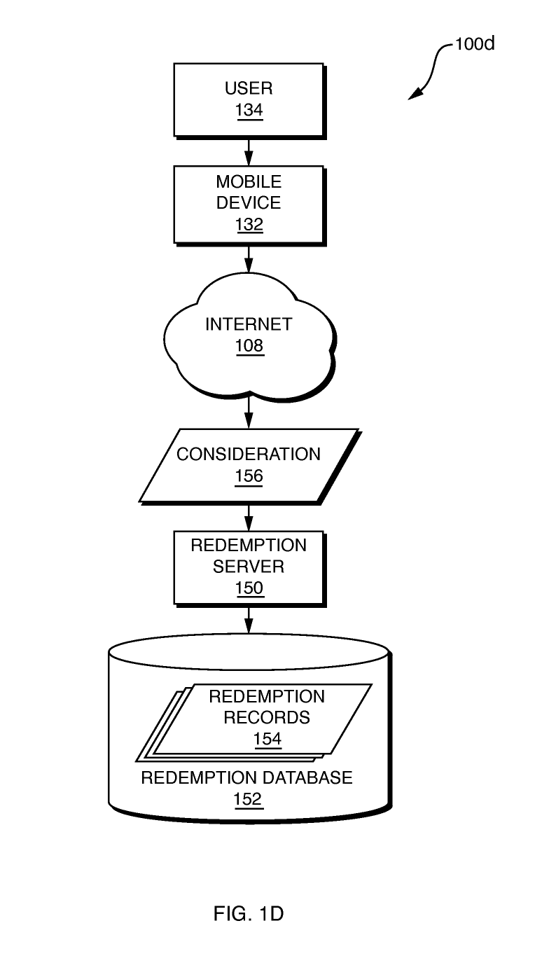

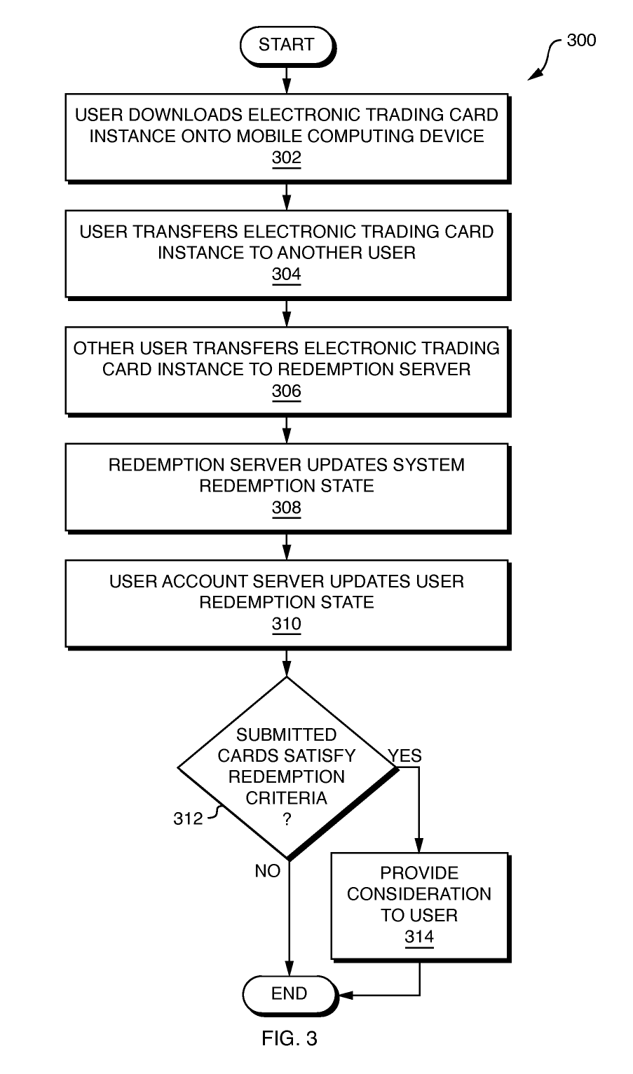

Referring to FIG. 1A, a dataflow diagram is shown of a system 100a for generating and distributing electronic trading cards according to one embodiment of the present invention. Referring to FIG. 3, a flowchart is shown of a method 300 that is performed by the system 100a of FIG. 1A according to one embodiment of the present invention. Certain elements of the system 100a and method 300 are described in more detail in the above-referenced patent application entitled, “Mobile Trading Card Generation and Distribution.” Such elements, therefore, will only be described summarily herein.

The system 100a includes a database 102 of electronic trading cards available for generation and distribution by the system 100a. A card server 104 provides an interface to the card database 102. The card server 104 may be accessible over a network 108, such as the public Internet. For example, the card server 104 (or a separate web server) may host a web site that provides access to the card database 102, as described below. In the following example, the card server 104 hosts an e-commerce website through which instances of cards in the card database 102 may be purchased.

A user 114 may access the card server 104, such as by using a web browser 112 on a mobile computing device 110 (e.g., a cell phone or personal digital assistant) to browse to the web site hosted by the card server 104. The user 114 downloads an instance 130 of an electronic trading card stored in the card database 102 over the network 108 and into the mobile computing device 110 (step 302). As described in the above-referenced patent application, the card 130 may be delivered as part of a pack containing multiple cards. As further described in the above-referenced patent application, the user 114 may pay for the card 130 or receive the card 130 for free.

Once the card instance 130 is stored on the mobile computing device 110, the user 114 may display information in the card instance 130 on a display screen of the mobile computing device 110. As described in more detail in the above-referenced patent application, displaying the card instance 130 may involve displaying still graphic images and/or video streams.

Furthermore, as shown in the system 100b of FIG. 1B, the user 114 may transfer the card instance 130 to a mobile computing device 132 of another user 134 (step 304). As described in more detail in the above-referenced patent application, the card instance 130 may be transmitted from the first mobile device 110 over the network 108 to the second mobile device 132, stored on the second mobile device 132, and removed from the first mobile device 110. As a result, in the current example only one copy of the electronic trading card instance 130 exists both before and after transference of the instance 130 from the first user 114 to the second user 134. Note, however, that deletion of the card instance 130 from the first mobile device 110 is optional.

One mechanism by which deletion of transferred cards may be enforced is the inclusion of digital rights management (DRM) in individual cards. DRM may be used to perform other functions, such as prohibiting duplication of card instances.

As shown in the system 100c of FIG. 1C, the second user 134 may transfer the electronic trading card instance 130 from the second mobile device 132 over the network 108 to a redemption server 150 (step 306). Alternatively, the original user 114 (or any other user in possession of the electronic trading card instance 130) may transmit the card instance 130 to the redemption server 150. For example, the second user 134 may send the electronic trading card instance 130 to yet another user (not shown), who may send the electronic trading card instance 130 to yet another user (not shown), and so on. Any such user may transmit the electronic trading card instance 130 to the redemption server 150. The following discussion, however, will refer to the second user 134 merely for purposes of example.

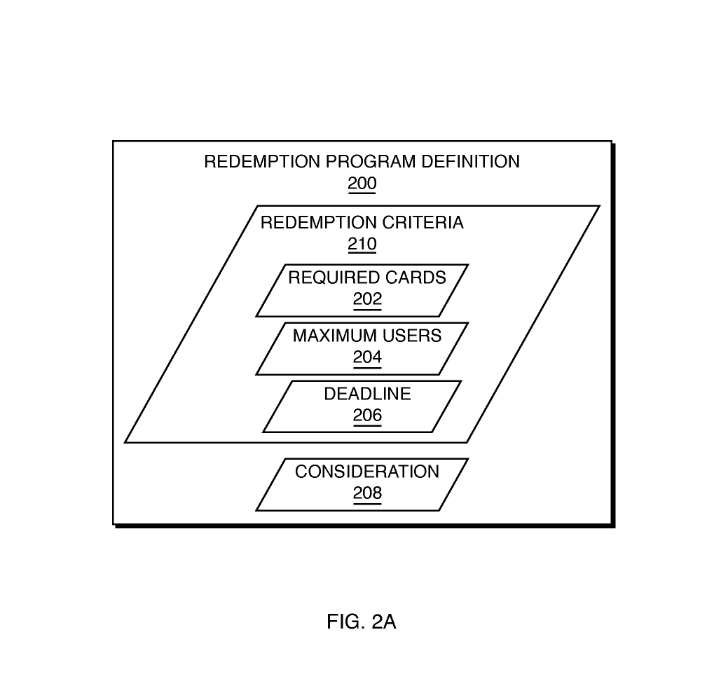

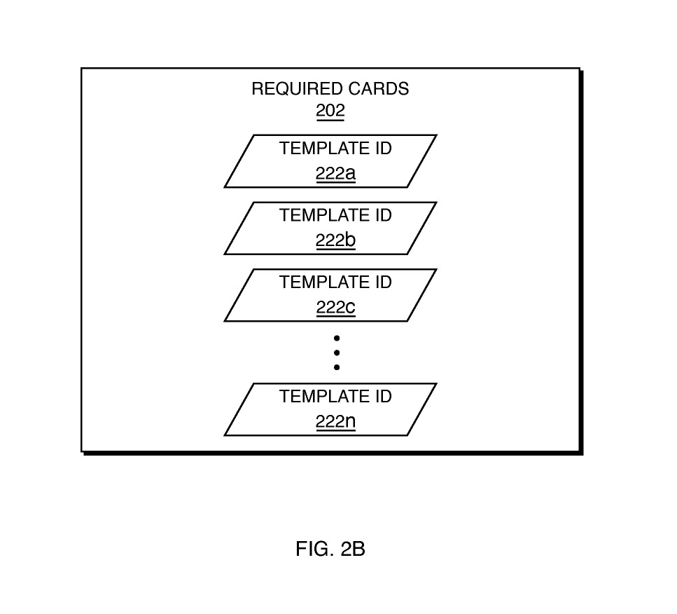

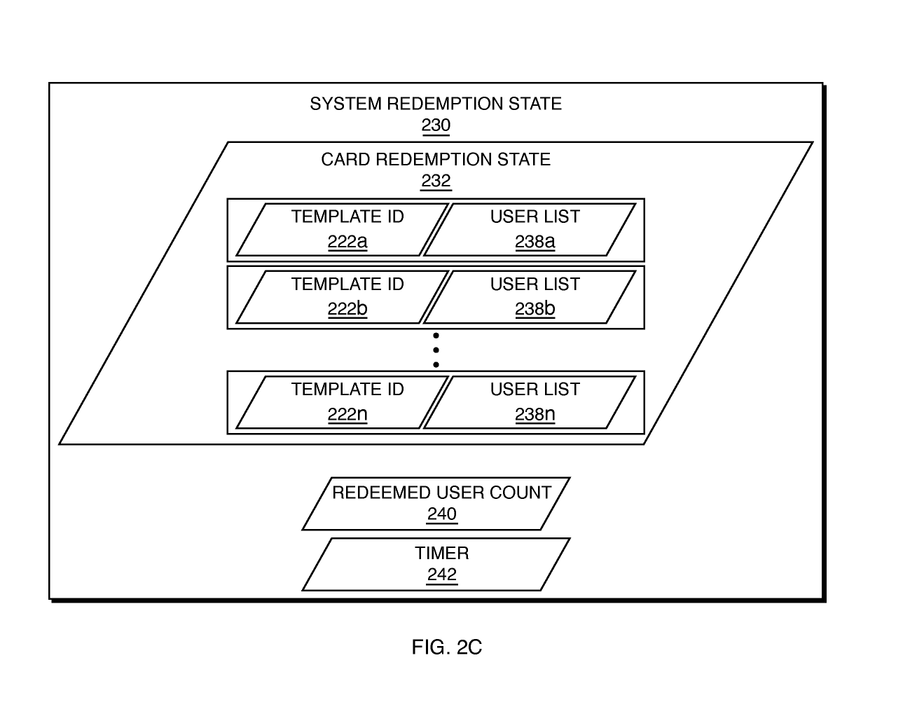

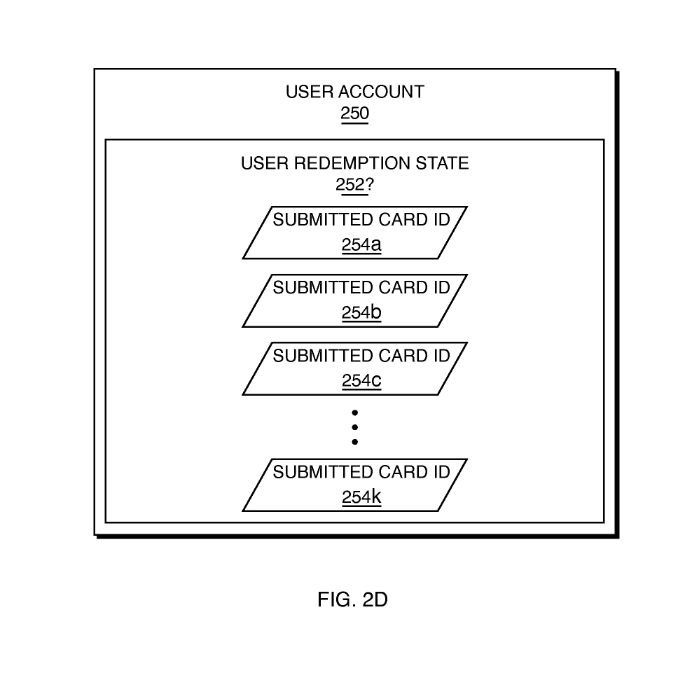

The redemption server 150 maintains a redemption database 152, which stores records 154 of redemption programs. The records 154 may include, for example, definitions of redemption programs. Referring to FIG. 2A, a diagram is shown illustrating the structure of a single redemption program definition record 200 according to one embodiment of the present invention. Although the redemption database records 154 may include multiple redemption program definition records, only a single such record 200 is shown in FIG. 2A for purposes of example.

In general, the redemption program definition record 200 illustrated in FIG. 2A defines one or more redemption criteria and the consideration to be provided to users who satisfy the redemption criteria. Consider, for example, a redemption program according to which users who redeem (return to the redemption server 150) at least one instance of each Boston Celtics electronic trading card are provided with a ticket to a Boston Celtics basketball game. In such an example, the single redemption criterion requires a user to return instances of all Boston Celtics electronic trading cards, and the consideration is a ticket to a Boston Celtics game.

The techniques disclosed herein are not limited to use with any particular kind of redemption criteria. FIG. 2A, however, illustrates the use of a particular class of redemption criteria. The redemption program definition record 200 specifies redemption criteria including: (1) a particular set of (one or more) electronic trading cards 202; (2) a maximum number of users 204; and (3) a deadline 206. The redemption program definition record 200 also specifies a consideration 208. In this example, the record 200 indicates that a user is entitled to receive the specified consideration 208 if the user provides, to the redemption server 150, at least one instance of all of the specified electronic trading cards 202 no later than the specified deadline 206, provided that no more than the specified maximum number of users 204 have already satisfied criteria 202 and 206. In other words, if M is the maximum number of users 204, then the redemption program definition record 200 indicates that up to M users who return instances of the cards 202 by the deadline 206 are entitled to receive the consideration 208.

The required cards 202 may be specified in any way. For example, in the above-referenced patent application, available electronic trading cards are divided into “sets.” Each card in the set is defined by a “template.” Each template specifies a maximum number of “instances” of the card that may be generated. Each instance of a template is provided with an identifier of the template, and a “series number” that uniquely identifies the instance among all instances of the same template. Therefore, any instance of any template may be uniquely identified among all cards generated by the system using a combination of the instance's template identifier and series number.

This is merely one example of techniques that may be used to generate and identify electronic trading cards, and does not constitute a limitation of the present invention. For example, each template may further be provided with a “set number” that uniquely identifies each set of cards. In such an example, each card instance may be uniquely identified among all cards generated by the system using a combination of the instance's set number, template identifier, and series number. As another example, each instance may be provided with a digital watermark. Such a digital watermark may be unique to the instance, the instance's template, or the instance's set. The digital watermark may also be used, either alone or in combination with other elements of an electronic card instance, to uniquely identify the electronic card instance.

Referring to FIG. 2B, a diagram is shown illustrating one way in which the set of required cards 202 may be represented in the redemption program definition 200. In the example illustrated in FIG. 2B, the required cards are represented by a set of template identifiers 222a-n, each of which identifies the template of a card required by the redemption program. In other words, a user must provide at least one instance of each template specified in the set of template identifiers 222a-n to be entitled to the consideration 208 defined by the redemption program definition record 200. Note that card instances having different series numbers and other characteristics may share the same template identifier. As a result more than one set of card instances may satisfy the criteria defined by the set of template identifiers 222a-n.

Returning to FIG. 2A, the maximum number of users 204 may be represented in any way. For example, it may be represented simply as a constant value (e.g., 100). Alternatively, for example, it may be represented by a formula or algorithm for calculating the maximum number of users. In the example illustrated in FIG. 2B, the consideration 208 is provided to at most the maximum number of users, even if additional users satisfy the other criteria 202 and 206 defined by the redemption program definition record 200.

Similarly, the deadline 206 may be represented in any way. For example, it may be represented as a particular combination of date and time (e.g., 10:00 A.M. on Jan. 1, 2007) or as a combination of a start time (e.g., Jan. 1, 2007 at midnight) and a countdown timer (e.g., 24 hours). In the example illustrated in FIG. 2B, the consideration 208 is not provided to any users after expiration of the deadline 206, even if such users satisfy the other criteria 202 and 204 defined by the redemption program definition record 200.

The redemption program records 154 (FIG. 1B) may also include records indicating the state of each defined redemption program. For example, referring to FIG. 2C, a diagram is shown illustrating a redemption state record 230 stored in the redemption database 152 according to one embodiment of the present invention. For purposes of example, the redemption state record 230 indicates the state of the redemption program defined by the redemption program definition record 200 shown in FIG. 2A. The redemption database 152 may include additional redemption state records for other defined redemption programs.

The redemption state record 230 includes a card redemption state field 232 indicating the redemption state of each of the required cards 202. In other words, the card redemption state field 232 indicates which users (if any) have returned instances of each of the cards required 202 by the corresponding redemption program.

Recall that in the present example there are n required cards specified by template identifiers 222a-n (FIG. 2B). Therefore, the card redemption state field 232 includes n entries 234a-n, each of which indicates the redemption state of the corresponding template. For example, entry 234a includes template identifier 222a (the same as the template identifier 222a in FIG. 2B) and a list 238a of users who have returned instances of the electronic trading card having the template identifier 222a. The user list 238a may, for example, identify users using identifiers defined in a separate user account database, described in more detail in the above-referenced patent application.

Similarly, entry 234b includes template identifier 222b and a list 238b of users who have returned instances of the electronic trading card having the template identifier 222b. The same is true for the remaining entries 234c-n, including entry 234n, which includes template identifier 222n and a list 238n of users who have returned instances of the electronic trading card having the template identifier 222n. In this way, the card redemption state field 232 indicates which users (if any) have returned instances of each of the cards required 202 by the corresponding redemption program.

The redemption state record 230 also includes a count 240 of the number of users who have already satisfied the redemption criteria 210 defined by the corresponding redemption program definition 200. For example, if five users have already provided at least one instance of each of the required cards 202 to the redemption server 150 before the specified deadline 206, then the count 240 would store the number five. The redemption server 150 may compare the count 240 to the maximum number of users 204 to determine when to stop providing the consideration 208 to users who have satisfied the other redemption program criteria 202 and 206.

The redemption state record 230 also includes a timer 242 indicating the amount of time that has elapsed since the beginning of the corresponding redemption program. Note that the timer may take any form, such as a count-down timer, a stopwatch, or a calendar. For example, if the corresponding redemption program began 30 minutes ago, the timer 242 may contain the value 1800 (30 minutes multiplied by 60 seconds per minute). The redemption server 150 may compare the timer 242 to the deadline 206 to determine when to stop providing the consideration 208 to users who have satisfied the other redemption program criteria 202 and 204.

Returning to FIGS. 1C and 3, when the user 134 transfers the card 130 to the redemption server 150, the redemption server 150 updates the appropriate redemption state record(s) in the redemption database 152 (step 308). The redemption server 150 may accomplish this in any of a variety of ways. For example, the redemption server 150 may identify the template identifier of the returned card 130, and search for the template identifier in all of the redemption program definition records stored in the redemption database 152. For any matching redemption program definition record that is found, the redemption server 152 may update the corresponding redemption state record to indicate that the user 134 has returned the card. For example, assume that the card 130 returned by the user 134 is one of the cards required 202 by the redemption program defined by record 200 (FIG. 2A). Assume further that the template identifier of card 130 is template identifier 22a. In such a case, the redemption server 150 may identify the user ID of the user 134 and add the user ID to the list of users 238a in the card redemption state field 232 of the redemption state record 230 (FIG. 2C). Examples of other techniques that may be used to identify the card 130 are described in the above-referenced concurrently-filed patent application.

Alternatively or additionally, the redemption server 152 may instruct 156 a user account server 144 (described in more detail in the above-referenced patent application) to update the account of the user 134 (stored in a set of user accounts 142 in a user account database 140) to indicate that the user 134 has returned the card 130 (FIG. 3, step 310). For example, referring to FIG. 2D, a diagram is shown illustrating a user account record 250 for the user 134. In the illustrated example, the user account record 130 indicates the redemption state 252 of the user 134 with respect to the redemption program defined by definition 200 (FIG. 2A). The redemption state 252 includes a set of template identifiers 254a-m of the card instances, if any, which the user 134 has returned to the redemption server 150 and which satisfy the redemption criteria 210 defined by the redemption definition 200.

As yet another alternative, the system 100c may store, in either the redemption database 152 or the user account database 140 or a combination thereof, a list of all of the card instances returned by each user. For example, the user account 250 may include a “checklist” of card instances returned by the user 134, without reference to the redemption programs(s) (if any) having criteria satisfied by those card instances. Those having ordinary skill in the art will recognize other ways to keep track of the card instances returned by users and to determine which redemption program criteria such card instances satisfy.

Regardless of the format in which the set of cards provided by the user 134 to the redemption server 150 is stored, the redemption server 150 may provide the user 134 with the ability to view a list or other visual representation of the cards provided so far by the user 134 to the redemption server 150. As described above, the user account server 144 may provide a web-based interface through which the user 134 may view information related to the user's account. The user account server 144 may, for example, display to the user 134 a list of cards provided so far by the user 134 to the redemption server 150. Such a list may, for example, indicate which cards are required by each outstanding (non-expired) redemption program, which ones of the required cards the user 134 has provided, and which cards the user 134 must still provide to satisfy the criteria of each outstanding redemption program. The list may further, for example, display timers indicating the amount of time until each outstanding redemption program expires, and the number of user slots still available for satisfying the redemption criteria for each program and for receiving the corresponding consideration.

After receiving the card 130 from the user 134, the redemption server 150 determines whether the cards returned by the user 134 satisfy the redemption criteria of any redemption programs defined in the redemption database 152 (FIG. 3, step 312). The redemption server 150 may, for example, identify the cards that the user 134 has returned to the server 150 so far (e.g., by reference to the list of cards 254a-k submitted by the user as shown in FIG. 2D) and determine whether such cards match the cards required 202 by the redemption definition 200 shown in FIG. 2A, and by any other redemption definitions defined in the redemption database 152. The redemption server 150 may limit its search to those redemption programs which have not already reached their maximum number of users or passed their deadline.

If the cards submitted by the user 134 so far satisfy a redemption program, the redemption server 150 provides the user 134 with the consideration offered by the redemption program (step 314). For example, if the redemption server 150 determines that the cards submitted by the user 134 so far satisfy the criteria 210 defined by the redemption program definition 200 illustrated in FIG. 2A, then the redemption server 150 may provide the user 134 with the consideration 208 defined by the redemption program definition 200.

The consideration 208 may take any of a variety of forms. For example, the consideration 208 may include one or more instances of electronic trading cards. For example, if the redemption program requires the user 134 to submit instances of ten electronic baseball cards representing ten specified ordinary baseball players, the consideration 208 may be an instance of an electronic baseball card representing a specified all-star player. In this example, the redemption program enables the user to “trade up” from a larger number of ordinary cards to a smaller number of special, possibly more scarce, cards.

As another example, the consideration 208 may include a ticket to an event, such as a sporting event. For example, if the redemption program requires the user 134 to submit instances of ten electronic basketball cards representing players on the Boston Celtics, the consideration 208 may be a ticket to a Boston Celtics basketball game. Similarly, the consideration 208 may include tickets to other kinds of events, such as movies and concerts.

As yet another example, the consideration 208 may include a physical or electronic coupon for a free or discounted product or service. For example, if the redemption program requires the user 134 to submit instances of ten electronic cards related to a movie, the consideration 208 may be a coupon for a free beverage and popcorn at a specified chain of movie theaters.

The redemption,server 150 may provide the user 134 with the consideration 208 in any of a variety of ways. For example, as shown in the system 100d of FIG. 1D, the redemption server 150 may provide consideration 156 over the network 108 to the user's mobile device 132. If, for example, the consideration 208 defined by the redemption program definition 200 is a particular electronic trading card, the consideration 156 transmitted by the redemption server 150 may be a particular instance of that electronic trading card. Other examples of consideration that may be transmitted over the network 108 include electronic tickets and coupons. Alternatively, the redemption server 150 may cause a printed card, ticket, coupon, or other consideration to be delivered to the user 134 by mail or other physical delivery mechanism.

Having generally described various embodiments of the present invention, particular embodiments of the present invention will now be described in more detail. The user 134 may transfer the electronic trading card instance 130 to the redemption server 150 by addressing the server 150 using a Common Short Code (CSC). The electronic trading card instances themselves may be transmitted using peer-to-peer (P2P) Multimedia Message Service (MMS) messages.

When the redemption server 150 receives the card instance. 130, the redemption server 150 may attempt to confirm the identity of the card instance 130. For example, the redemption server 150 may determine whether the template ID and series number of the card instance 130 match the template ID and series number of a card instance previously distributed by the card server described in the above-referenced related patent application. Furthermore, the redemption server 150 may determine whether the template ID and series number of the card instance 130 are the same as the template ID and series number of any card instance already received by the redemption server 150, indicating a possible error or unauthorized copy.

If the redemption server 150 cannot identify the card instance 130, the redemption server 150 may transmit a Short Message Service (SMS) message to the user 114 indicating an error and asking the user 134 to try to transfer the same card instance 134 again, or to try to transfer a different card instance to the server 150.

The redemption server 150 may also determine (through the user account server 144) whether the user 134 already has an account in the user account database 140. If the user 134 does not have an account, the user account server 144 may send an SMS message to the user 134 providing instructions for creating an account. The user 134 may be prohibited from taking part in redemption programs without a user account.

If/when the identity of the card instance 130 and the user 134 have been verified, the redemption server 150 may determine whether the user 134 has already provided the server 150 with another instance of the same card (e.g., another card instance having the same template ID). If the user 134 has already provided the server 150 with another such card instance, the server 150 may send an SMS message to the user 134 informing him or her of this fact. Otherwise, the redemption server 150 may add the card instance 130 to the user's checklist and transmit a Short Message Service (SMS) message back to the user 134, confirming that the card instance 130 has been received and added to the user's checklist.

The techniques disclosed herein may be used to effectively replicate the visual appeal, market dynamics and viral nature of a traditional card trading paradigm. The electronic trading card generation and distribution techniques disclosed herein may spur the development of a new content category on the mobile phone-card trading. Card trading appeals to sports fans, as well as music, movies, gaming, shopping and collecting enthusiasts. The development of mobile trading cards enables companies to create viral marketing campaigns around both new and existing content in a simple and intuitive way.

The generation and distribution of limited numbers of unique electronic trading cards creates a kind of scarcity in digital content that is analogous to the scarcity that has long existed in printed trading cards. The techniques disclosed herein, like in their printed analogs, may be used to create a set containing a finite number of cards, and to create a finite number of instances (copies) of each card in a set. Such scarcity drives demand. Digital technology, however, enables even instances of the same card to vary from each other, such as through the use of the variable facts discussed herein. Such techniques create a degree of scarcity not before possible, thereby enabling further demand to be created for electronic trading cards.

Such scarcity may be leveraged to add value to individual units of digital content. For example, a single instance of an electronic trading card may have relatively little value. Ten instances of such a trading card, however, may have a redemption value greater than the sum of the values of the individual instances.

Furthermore, the unique nature of each card instance enables each card instance to be tracked to the user to whom it was originally transmitted. This tracking feature may, for example, be used to flag potential “super users” or “web posters,” as well as to learn more about “trading” communities. Furthermore, when a user provides an instance of an electronic trading card back to the system, the system may not only identify the user who provided the card instance to the system, but also use the unique identifier of the card instance to identify the original purchaser/recipient of the card. Such information may be used, for example, to analyze the social networks linking card traders.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions. For example, the card server 104, user account server 144, and redemption server 150 may be combined into fewer components or separated into a greater number of components for performing the same functions. Furthermore, use of terms such as “client” and “server” are not intended to limit the techniques disclosed herein to client/server architectures. Rather, any “client” or “server” disclosed herein may be implemented as a client, server, or in any manner for performing the disclosed function(s). For example, the “redemption server” may be considered more generally to be a “redemption processor,” which need not be implemented as a server.

Redemption programs may be created and defined in any manner. For example, a redemption program may be created by or on behalf of a corporate sponsor, such as a baseball team or a film studio. In such examples, the redemption criteria may require users to collect and provide instances of cards related to a particular corporate product or service (such as a film or sporting event), and the corresponding consideration may be a reward or prize related to that corporate product or service (such as a ticket to the film or sporting event).

Furthermore, redemption criteria may define criteria other than those defining a particular set of electronic trading cards. For example, a particular set of redemption criteria may specify a minimum number of cards required, without specifying identities of particular required cards. As another example, a particular set of redemption criteria may specify a type or types of cards required, without specifying identities of particular required cards. These are merely examples of redemption criteria and do not constitute limitations of the present invention.

Redemption programs may, however, be created by individuals and need not be commercial in nature. For example, an individual desiring a particular group of baseball cards may use the redemption server 150 to create a redemption program in which the required cards are the cards desired by the individual. In exchange, the individual may provide as consideration a particularly valuable baseball card in the individual's possession.

Even more generally, the term “redemption program” as used herein refers to programs in which there is no consideration. For example, the redemption server 150 may enable users to provide instances of electronic trading cards to the server 150 merely for purposes of tracking cards obtained by such users. In such a case, when a user transfers an instance of an electronic trading card to the redemption server 150, the redemption server stores an indicating that the user has transferred the instance of the electronic trading card to the redemption server 150. The user may then view a report of the electronic trading cards the user has transferred to the redemption server 150. More generally, therefore, the redemption server 150 may be considered to be a “tracking server” for tracking digital content provided by users.

“Transmitting” an instance of an electronic trading card to the redemption server 150 may involve transmitting the entire content of the card instance or a subset thereof. Alternatively, “transmitting” an instance of an electronic trading card to the redemption server 150 may involve transmitting an identifier of the electronic trading card instance to the redemption server 150 and thereby registering the card instance with the redemption server 150. When an electronic trading card instance is “transmitted” to the redemption server 150, the instance may or may not be removed from the mobile computing device of the user.

Furthermore, the techniques disclosed herein are not limited to tracking electronic trading cards. Rather, the techniques disclosed herein may be used to track any kind of digital content. Therefore, references herein to instances of electronic trading cards are equally applicable to units of digital content more generally. For example, the techniques disclosed herein may be applied to digital lottery tickets.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not'shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) identifying at least one electronic trading card instance transmitted by a user over a network to a redemption processor;
(B) determining whether the at least one electronic trading card instance satisfies at least one predetermined redemption criterion; and
(C) if the at least one electronic trading card instance satisfies the at least one predetermined redemption criterion, providing the user with predetermined consideration in exchange for the at least one electronic trading card instance.

2. The method of claim 1, further comprising:
(D) before (A), receiving the at least one electronic trading card instance over the network from the user.

3. The method of claim 1, further comprising:
(D) before (A), transmitting the at least one electronic trading card instance over the network to the user.

4. The method of claim 1, wherein (C) comprises transmitting the consideration to the user over the network.

5. The method of claim 1, wherein the at least one predetermined redemption criterion specifies a plurality of identifiers of a plurality of electronic trading cards, and wherein (B) comprises determining whether the at least one electronic trading card instance has the specified plurality of identifiers.

6. The method of claim 5, wherein the at least one electronic trading card instance includes an image, and wherein (B) comprises determining whether the image satisfies the at least one predetermined redemption criterion.

7. The method of claim 1, wherein the at least one predetermined redemption criterion specifies a maximum number of users and at least one other predetermined redemption criterion, and wherein (B) comprises determining whether the at least one other predetermined redemption criterion has been satisfied by fewer than the maximum number of users.

8. The method of claim 1, wherein the at least one predetermined redemption criterion specifies a time and at least one other predetermined redemption criterion, and wherein (B) comprises determining whether the at least one other predetermined redemption criterion has been satisfied before the specified time.

9. The method of claim 1, further comprising:
(D) before (A), transmitting the at least one electronic trading card instance over the network to another user.

10. The method of claim 1, wherein (C) comprises providing the user with an electronic trading card instance not included in the at least one electronic trading card instance.

11. An apparatus comprising:
identification means for identifying at least one electronic trading card instance transmitted by a user over a network to a redemption processor;
criterion verification means for determining whether the at least one electronic trading card instance satisfies at least one predetermined redemption criterion; and
consideration means for providing the user with predetermined consideration in exchange for the at least one electronic trading card instance if the at least one electronic trading card instance satisfies the at least one predetermined redemption criterion.

12. The apparatus of claim 11, further comprising:
trading card reception means for receiving the at least one electronic trading card instance over the network from the user.

13. The apparatus of claim 11, further comprising:
trading card transmission means for transmitting the at least one electronic trading card instance over the network to the user.

14. The apparatus of claim 11, wherein the consideration means comprises means for transmitting the consideration to the user over the network.

15. The apparatus of claim 11, wherein the at least one predetermined redemption criterion specifies a plurality of identifiers of a plurality of electronic trading cards, and wherein the criterion verification means comprises means for determining whether the at least one electronic trading card instance has the specified plurality of identifiers.

16. The apparatus of claim 11, further comprising:
trading card transmission means for transmitting the at least one electronic trading card instance over the network to another user.

17. A computer-implemented method comprising:
(A) transmitting at least one electronic trading card instance over a network to a redemption processor, the at least one electronic trading card instance satisfying at least one predetermined redemption criterion; and
(B) receiving predetermined consideration in exchange for the at least one electronic trading card instance.

18. The method of claim 17, further comprising:
(C) before (A), receiving the at least one electronic trading card instance over the network.

19. The method of claim 17, wherein (B) comprises receiving the consideration over the network.

20. The method of claim 17, wherein the at least one predetermined redemption criterion specifies a plurality of identifiers of a plurality of electronic trading cards, and wherein the at least one electronic trading card instance has the specified plurality of identifiers.

21. The method of claim 20, wherein the at least one electronic trading card instance includes an image satisfying the at least one predetermined redemption criterion.

22. The method of claim 17, wherein the at least one predetermined redemption criterion specifies a maximum number of users and at least one other predetermined redemption criterion, and wherein the at least one other predetermined redemption criterion has been satisfied by fewer than the maximum number of users.

23. The method of claim 17, wherein the at least one predetermined redemption criterion specifies a time and at least one other predetermined redemption criterion, and wherein the at least one other predetermined redemption criterion has been satisfied before the specified time.

24. The method of claim 17, further comprising:
(C) before (A), receiving the at least one electronic trading card instance over the network from another user.

25. The method of claim 17, wherein (B) comprises receiving an electronic trading card instance not included in the at least one electronic trading card instance.

26. An apparatus comprising:
trading card transmission means for transmitting at least one electronic trading card instance over a network to a redemption processor, the at least one electronic trading card instance satisfying at least one predetermined redemption criterion; and
consideration reception means for receiving predetermined consideration in exchange for the at least one electronic trading card instance.

27. The apparatus of claim 26, further comprising:
trading card reception means for receiving the at least one electronic trading card instance over the network.

28. The apparatus of claim 26, wherein the consideration reception means comprises means for receiving the consideration over the network.

29. The apparatus of claim 26, wherein the at least one predetermined redemption criterion specifies a plurality of identifiers of a plurality of electronic trading cards, and wherein the at least one electronic trading card instance has the specified plurality of identifiers.

30. The apparatus of claim 26, further comprising:
means for receiving the at least one electronic trading card instance over the network from another user.

31. The apparatus of claim 26, wherein the consideration reception means comprises means for receiving an electronic trading card instance not included in the at least one electronic trading card instance.

32. A computer-implemented method comprising:
(A) receiving an indication of a digital content unit transmitted by a transmitting user over a network to a tracking server;
(B) identifying the transmitting user; and
(C) storing an indication that the transmitting user has transmitted the digital content unit to the tracking server.

33. The method of claim 32, wherein (A) comprises receiving the digital content unit from the transmitting user.

34. The method of claim 32, further comprising:
(D) before (A), transmitting the digital content unit over the network to the transmitting user.

35. The method of claim 32, wherein (C) comprises updating a record of digital content units transmitted by the transmitting user to the tracking server to indicate that the transmitting user has transmitted the digital content unit to the tracking server.

36. The method of claim 32, further comprising:
(D) before (A), transmitting the digital content unit over the network to a user other than the transmitting user.

37. The method of claim 36, wherein (C) comprises storing an identity of the transmitting user and an identity of the user other than the transmitting user.

38. The method of claim 32, further comprising:
(D) repeating (A)-(C) for a plurality of digital content units; and
(E) providing to the user a report of the plurality of digital content units received from the transmitting user.

39. The method of claim 32, wherein the digital content unit comprises an electronic trading card instance.

40. The method of claim 32, wherein (A) comprises receiving an indication of a digital content unit transmitted by the transmitting user from a mobile computing device.

41. An apparatus comprising:
reception means for receiving an indication of a digital content unit transmitted by a transmitting user over a network to a tracking server;
identification means for identifying the transmitting user; and
storage means for storing an indication that the transmitting user has transmitted the digital content unit to the tracking server.

42. The apparatus of claim 41, wherein the reception means comprises means for receiving the digital content unit from the transmitting user.

43. The apparatus of claim 41, further comprising:
means for transmitting the digital content unit over the network to the transmitting user.

44. The apparatus of claim 41, wherein the storage means-comprises means for updating a record of digital content units transmitted by the transmitting user to the tracking server to indicate that the transmitting user has transmitted the digital content unit to the tracking server.

45. The apparatus of claim 41, further comprising:
means for transmitting the digital content unit over the network to a user other than the transmitting user.

46. The apparatus of claim 41, wherein the digital content unit comprises an electronic trading card instance.
